(19) United States
(12) Patent Application Publication
(10) Pub. No.: US 2025/0278688 A1
(43) Pub. Date: Sep. 4, 2025

(54) SYSTEM AND METHOD FOR GENERATING EVALUATION FORMS

(71) Applicant: NICE LTD., Ra'anana (IL)

(72) Inventors: Prasad PATIL, Pune (IN); Pankul GUPTA, TARNTARAN (IN); Govind BISHT, Pune (IN); Brijesh UPADHYAY, Pune (IN); Abhijit MOKASHI, Pune (IN)

(73) Assignee: NICE LTD., Ra'anana (IL)

(21) Appl. No.: 18/591,677

(22) Filed: Feb. 29, 2024

(51) Int. Cl. G06Q 10/0639; G06F 40/20

(52) U.S. Cl. CPC G06Q 10/06398; G06F 40/20

(57) ABSTRACT

A system and method for generating evaluation forms from interaction recordings may include a computing device; a memory; and a processor, the processor configured to: identify one or more interaction intents from an interaction transcript; generate one or more evaluation categories for the one or more interaction intents using machine learning; generate evaluation questions for the one or more evaluation categories using machine learning; and provide an evaluation form based on the evaluation questions.

### TECHNICAL FIELD OF THE INVENTION

The present invention relates generally to the automatic generation of text such as evaluation forms, for example the generation of evaluation forms for the evaluation of agents in contact centers using interaction recordings.

### BACKGROUND OF THE INVENTION

Evaluation forms are frequently used to collect information when evaluating entities, such as workers, such as in the assessment of agents in agent customer interactions of contact centers.

However, the generation of evaluation forms may require in depth knowledge in the specific technological field to generate evaluation forms that are targeted to the agent's tasks. Thus, contact centers may commonly rely on domain experts, external agencies, or paid templates for the provision of evaluation forms.

Poorly drafted questions in evaluation forms may result in misinterpretation of agent behavior and may result in inaccurate evaluation results leading to the need for manual correction of evaluation scores or evaluation forms.

In addition, evaluation forms may require periodic maintenance, e.g. updating of evaluation questions based on new services or products that are released by businesses.

Thus, there is a need for a solution that allows for automatically generating evaluation forms for agents of contact centers that are based on processed interaction recordings of interactions with customers.

### SUMMARY OF THE INVENTION

Improvements and advantages of embodiments of the invention may include automatically generating and updating evaluation forms, e.g. for the evaluation of agents of a contact center based on content present in interaction recordings, e.g. an interaction recording for an interaction between an agent using an agent device and customer using a customer device.

The automatic generation of evaluation forms may increase the accuracy of evaluation questions, e.g. of a service provided by an agent of a contact center to a customer. For example, changes to a provided service, e.g. new specifications of a service or of a product, may be automatically implemented in evaluation forms and, thus, may allow quick response times to changes in the evaluation of agents.

In particular, improvements and advantages of embodiments of the invention may include automatically adjusting evaluation questions to a provided service based on the automated processing of interaction transcripts, e.g. evaluation of agents of a contact center for communication services may require evaluation questions specific to communication service related issues and problem solving whereas evaluation of agents of a contact center for public services may require evaluation questions specific to administrative or public services.

One embodiment may include a method of automatically generating evaluation forms from interaction recordings, the method including: identifying one or more interaction intents from an interaction transcript; generating one or more evaluation categories for the one or more interaction intents using machine learning; generating evaluation questions for the one or more evaluation categories using machine learning; and providing an evaluation form from the evaluation questions.

In one embodiment, new interaction intents are identified within the one or more interaction intents by comparing the one or more identified interaction intents with recorded interaction intents of an interaction intent database.

In one embodiment, the one or more evaluation categories are generated from the new interaction intents identified in the interaction transcript.

In an embodiment, identifying one or more interaction intents includes providing the machine learning model with an intent identification prompt including a part of the interaction transcript.

In an embodiment, generating one or more evaluation categories includes providing the machine learning model with a category generation prompt comprising the one or more identified intents.

In one embodiment, the generated evaluation questions are used to update evaluation questions in previously generated evaluation forms.

In an embodiment, generating evaluation questions includes providing the machine learning model with a question generation prompt including the one or more identified intents, the one or more evaluation categories, and a number setting a limit for generated evaluations questions for each of the one or more evaluation categories.

In one embodiment, the question generation prompt includes a customer domain. In one embodiment, the machine learning model is a large language model.

In one embodiment, the generated evaluation forms are periodically updated based on interaction intents which have been identified in subsequent interactions.

In one embodiment, the updating of generated evaluation forms includes generating a refinement prompt that includes evaluation questions and submitting the refinement prompt to a machine learning model.

One embodiment may include a system for generating evaluation forms from interaction recordings, the system including: a computing device; a memory; and a processor, the processor configured to: identify one or more intents from an interaction transcript; generate one or more evaluation categories for the one or more interaction intents using machine learning; generate evaluation questions for the one or more evaluation categories using machine learning; and provide an evaluation form based on the evaluation questions.

One embodiment may include for generating evaluation forms from transcripts, wherein the method includes: identifying at least one intent in an transcript; creating at least one evaluation category for the at least one intent using machine learning; creating evaluation questions for the at least one evaluation category using machine learning; and generating an evaluation form based on the evaluation questions.

These, additional, and/or other aspects and/or advantages of the present invention may be set forth in the detailed description which follows; possibly inferable from the detailed description; and/or learnable by practice of the present invention.

### BRIEF DESCRIPTION OF THE DRA WINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

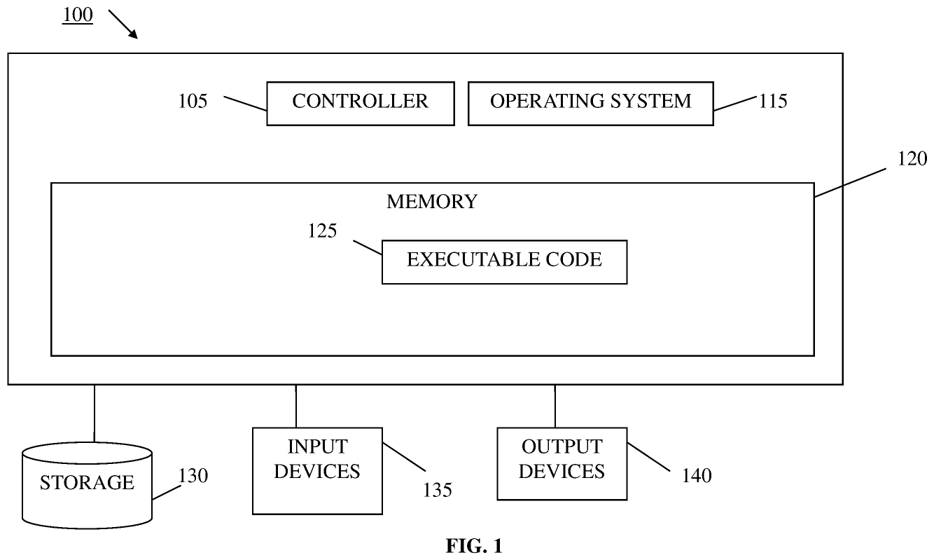

FIG. 1 shows a block diagram of an exemplary computing device which may be used with embodiments of the present invention.

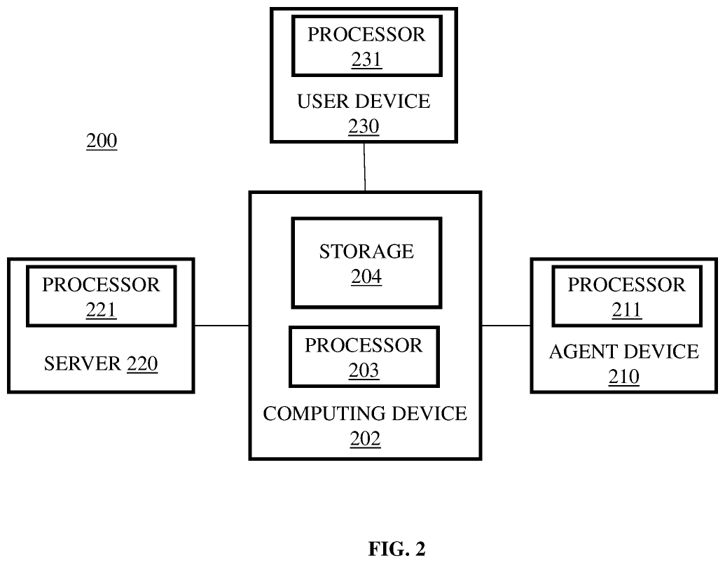

FIG. 2 is a schematic drawing of a system for generating evaluation forms from interaction transcripts, according to some embodiments of the invention.

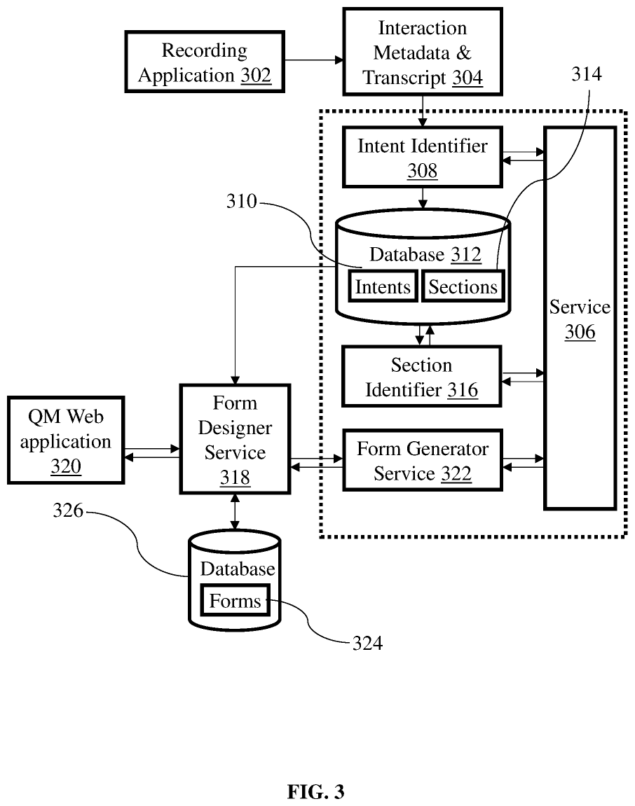

FIG. 3 is a schematic drawing of a system for generating evaluation forms from interaction transcripts, according to some embodiments of the invention.

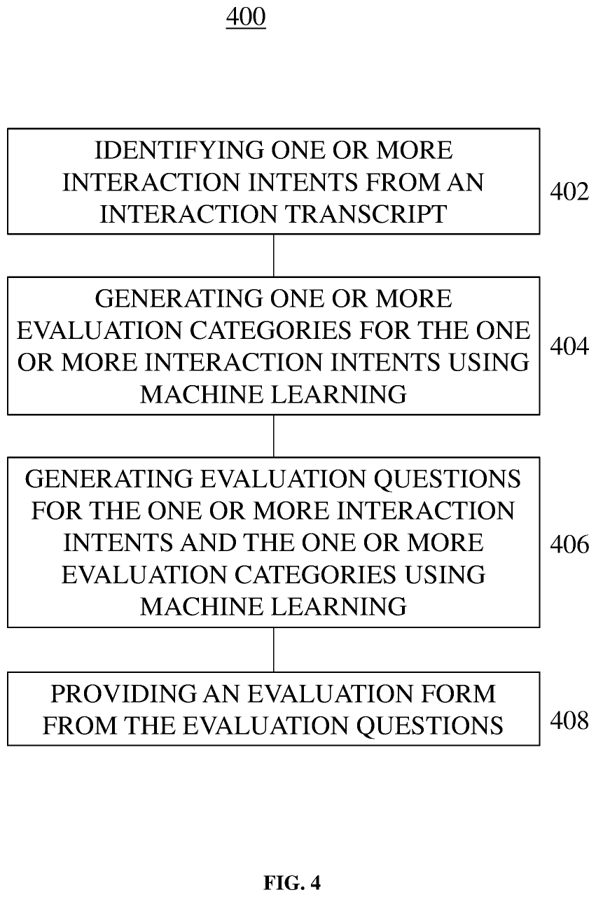

FIG. 4 depicts a flowchart of methods of generating evaluation forms from interaction transcripts, according to some embodiments of the present invention.

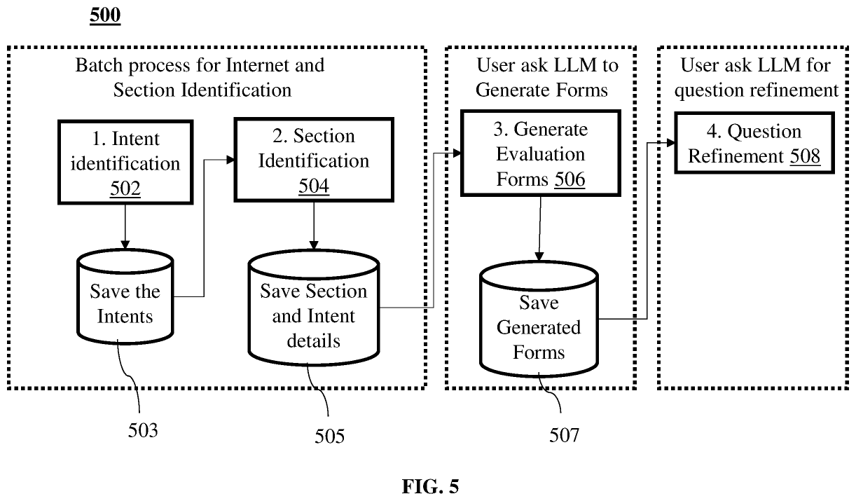

FIG. 5 is a schematic drawing illustrating data processing in the generation of evaluation forms from interaction transcripts, according to some embodiments of the invention.

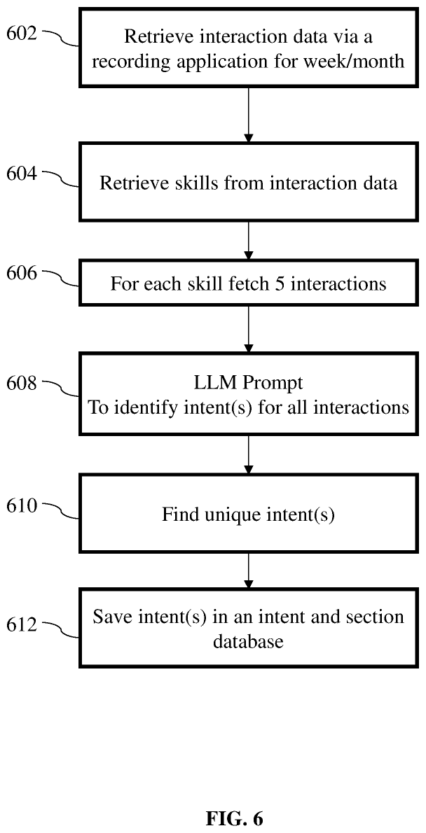

FIG. 6 depicts a flowchart illustrating operations in the identification of intents, according to some embodiments of the present invention.

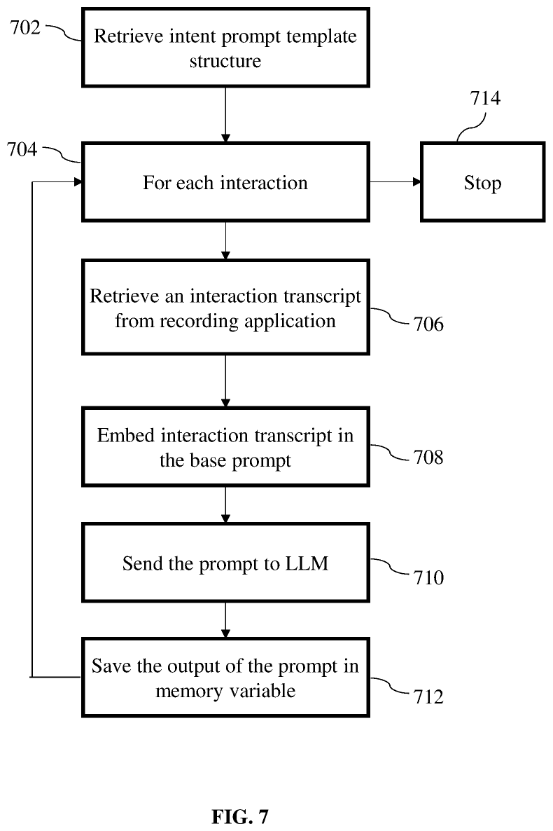

FIG. 7 depicts a flowchart illustrating operations in the generation of an LLM prompt for the intent identification as depicted in FIG. 6 in the identification of intents, according to some embodiments of the present invention.

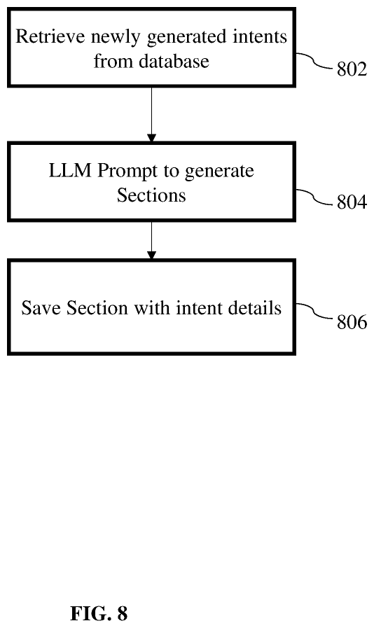

FIG. 8 depicts a flowchart illustrating operations in the identification of sections, according to some embodiments of the present invention.

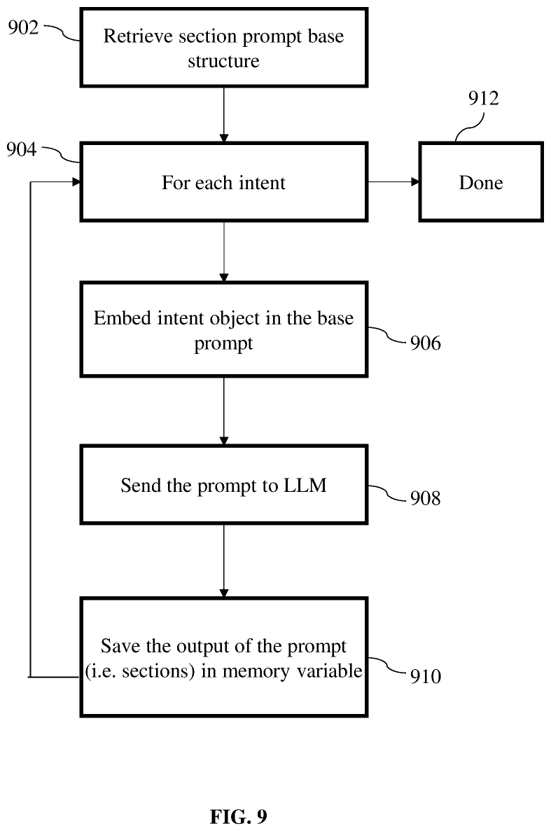

FIG. 9 depicts a flowchart illustrating operations in the generation of an LLM prompt for the section generation as depicted in FIG. 8 in the identification of sections, according to some embodiments of the present invention.

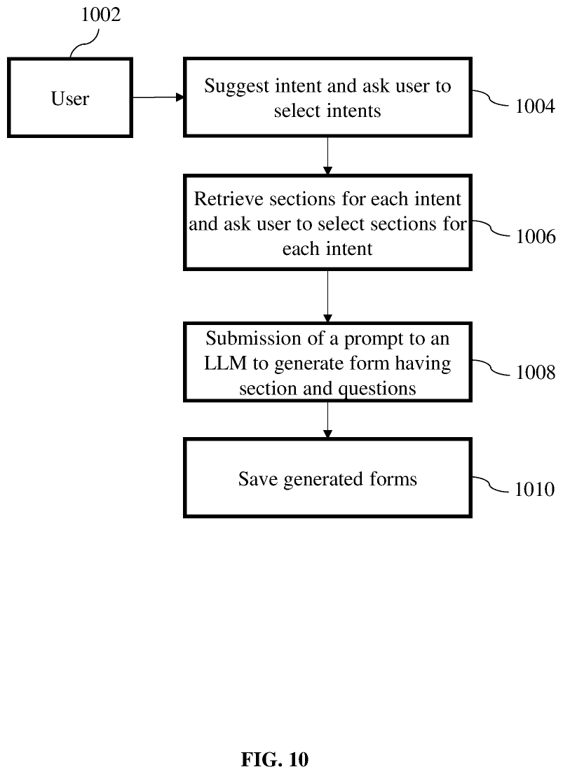

FIG. 10 depicts a flowchart illustrating operations in the generation of evaluation forms, according to some embodiments of the present invention.

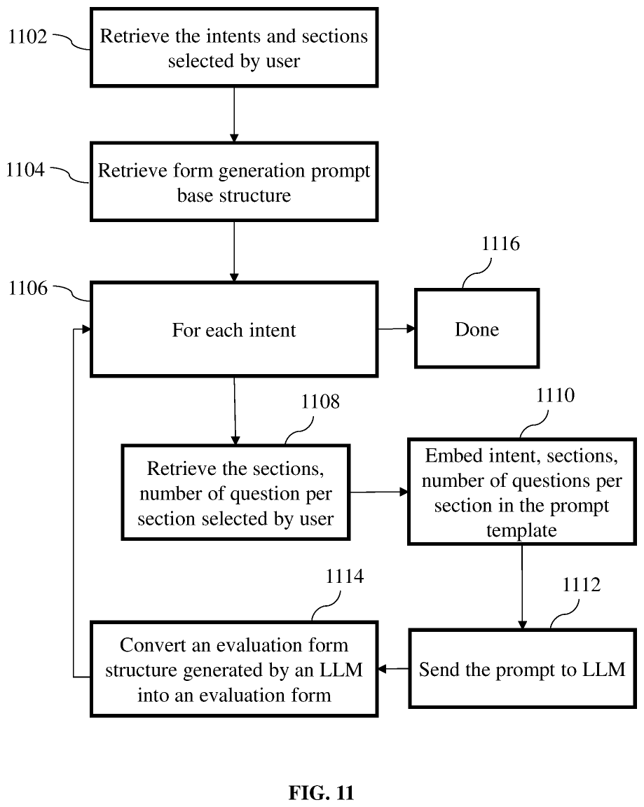

FIG. 11 depicts a flowchart illustrating operations in the submission of a prompt to a LLM in the generation of evaluation forms as depicted in FIG. 10 in the generation of evaluation forms, according to some embodiments of the present invention.

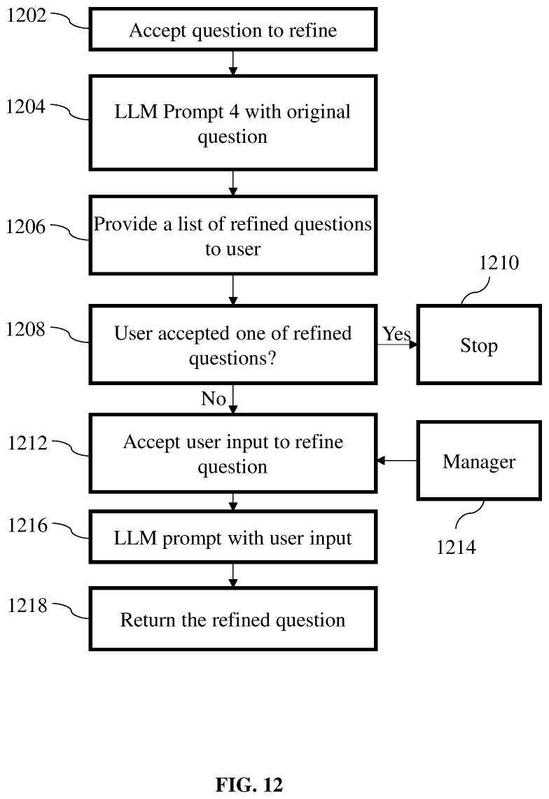

FIG. 12 depicts a flowchart illustrating operations in the updating of evaluation forms, according to some embodiments of the present invention.

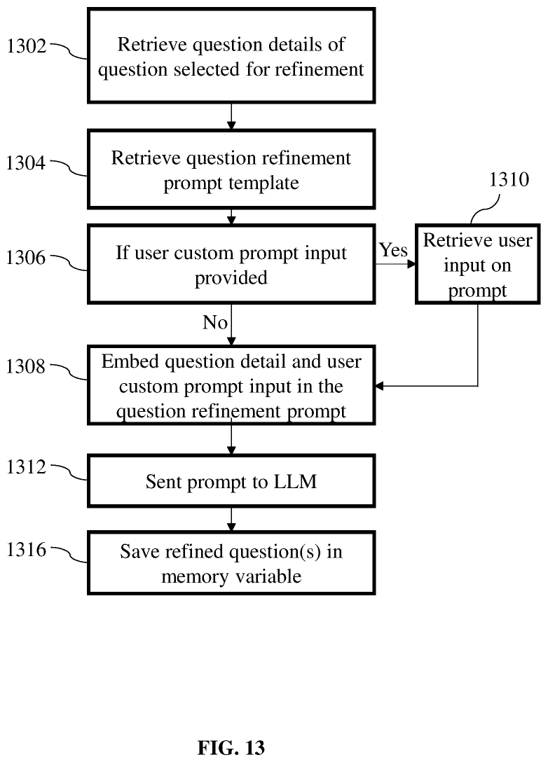

FIG. 13 depicts a flowchart illustrating operations in the generation of an LLM prompt for the refinement of evaluation forms shown in FIG. 12, according to some embodiments of the present invention.

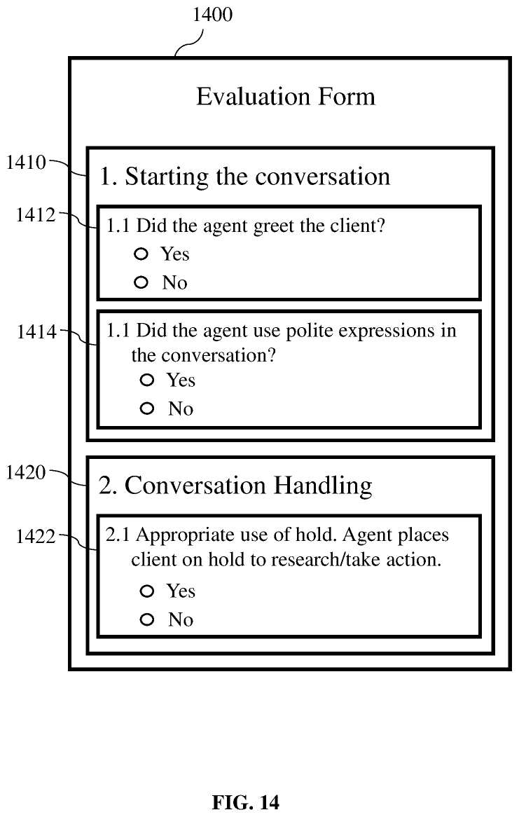

FIG. 14 depicts an example evaluation form, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “contact center” may refer to a centralized office used for receiving or transmitting a large volume of enquiries, communications, or interactions. The enquiries, communications, or interactions may utilize telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), emails, web chats, SMS messages, etc. An interaction may be recorded to generate an “interaction recording”. An interaction recording may also refer to the data which is transferred and stored in a computer system recording the interaction, the data representing the interaction, including for example voice or video recordings, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), emails, web chats, SMS messages, etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages. An interaction may take place using text data, e.g., email, web chat, SMS, etc., or an interaction may not be text-based, e.g., voice telephone calls. Non-text-based interactions may be converted into text-based interaction recordings (e.g., using automatic speech recognition). Interaction data and Interaction recordings may be produced, transferred, received, etc., asynchronously.

As used herein, “user” may refer to a contact center employee that provides training to agents of a contact centers and evaluates the performance of agents, e.g. by analyzing interaction evaluation forms.

As used herein, “agent” may refer to a contact center employee that answers incoming interactions, and may, for example, handle customer requests. While evaluation forms when described herein in some examples are used for agents in contact centers, in other embodiments such forms may be used to evaluate other entities, people, etc.

An “intent” may refer to a customer's intention or purpose behind a specific action or request, or the description of that intention or purpose, e.g. the initiation of an interaction such as a phone call. An intent can be, for example, the request of a certain information, performing a specific task such as providing product information for product A, cancellation requests of a service B or shipping and delivery of an item C. Intents may be stored in a database, e.g. in an intent and section database 312. An “intent” in a transcript can be text actually occurring in the transcript which expresses intent, or it can be a textual description of intent using words which may not appear in the transcript.

A “new interaction intent” may be an intent identified in an interaction transcript that has not been identified in an intent database, e.g. an intent and section database 312 of FIG. 3.

Terms such as “category”, “evaluation category”, “evaluation section” or “section” may refer to or describe an item that is part of an intent. For example, an intent such as an intent “customer query” may include several items or categories that further describe the intent. An intent “customer query” may include categories or sections such as “customer information”, “account verification”, “inquiry details” or “follow-up and next steps”. Each of the categories or sections can further specify the type of customer query that has been identified in an interaction or for which an evaluation is desired.

An “evaluation form” may be a form or document that is used, for example, in the evaluation of agents of a contact center. An evaluation form may include questions that can allow the assessment of an agent, and may include sections for an evaluator to enter answers to the questions. For example, agents may be assessed in their behavior in interaction with customers. Evaluation forms may include questions that are specific for intents or sections that have been identified in previous interaction recordings. Intents and sections recorded for interactions may allow generating evaluation forms that include questions that are tailored to a specific task of an agent of a contact center. For example, a worker such as an agent that predominantly deals with issues related to order placements, e.g. queries of customers whether or not an order has been placed, may be evaluated based on an evaluation form that includes evaluation questions specific to the intent “order placement” or to sections/categories such as “shipping and delivery”, “quantity and customization”, “product/service details” or “additional accessories of services” that further describe the intent “order placement”. An evaluation form may be sent, along with an evaluation, to an evaluator, who may enter information into the evaluation form (or another document) based on the questions in the form.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was satisfactory. In an unsupervised ML approach, the input sample data may not include any labels, for example, in the present application, the input sample data may include interaction transcripts only.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. computing device 202, agent device 210, customer device 220, user device 230, a intent identifier 308, section identifier 316, form generator service 322 or a form designer service 318, and modules in FIGS. 2, 3, 4, 5, 6, 7, 8, 9, 10, 11, 12, 13 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is a schematic drawing of a system 200 according to some embodiments of the invention. System 200 may include a computing device 202 including a processor 203 and storage 204. Computing agent device 202 may be connected to an agent device 210 that includes processor 211. Computing device 202 may be connected to a server 220 including processor 221. Computing device 202 may be connected to a user device 230 including processor 231. Server 220 and Agent device 210 may provide computing device 202 with interaction recordings. Alternatively, interaction recordings may be stored in storage 204 of computing device 202.

Computing devices 100, 202, 210, 220 and 230 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 100, 202, 210, 220 and 230 may include one or more input devices, for receiving input from a user (e.g., via a pointing device, click-wheel or mouse, keys, touch screen, recorder/microphone, or other input components). Computers 100, 202, 210, 220 and 230 may include one or more output devices (e.g., a monitor, screen, or speaker) for displaying or conveying data to a user.

Any computing devices of FIGS. 1 and 2 (e.g., 100, 202, 210, 220 and 230), or their constituent parts, may be configured to carry out any of the methods of the present invention. Any computing devices of FIGS. 1 and 2, or their constituent parts, may include a intent identifier 308, section identifier 316, form generator service 322 or a form designer service 318, or another engine or module, which may be configured to perform some or all of the methods of the present invention. Systems and methods of the present invention may be incorporated into or form part of a larger platform or a system/ecosystem, such as agent management platforms. The platform, system, or ecosystem may be run using the computing devices of FIGS. 1 and 2, or their constituent parts. For example, a processor such as processor 203 of computing device 202 processor 211 of device 210, and/or processor 221 of computing device 220 may be configured to identify one or more interaction intents, such as “customer inquiry”, “order placement”, technical support “, billing and payments”, “product information”, “shipping and delivery” from an interaction transcript. A processor such as processor 203 of computing device 202 processor 211 of device 210, and/or processor 221 of computing device 220 may be configured to generate one or more evaluation categories for the one or more interaction intents using machine learning. For example, a processor such as processor 203, 211 and/or 221 may be configured to create at least one evaluation category for the at least one interaction intent using machine learning. A processor such as processor 203 of computing device 202 processor 211 of device 210, and/or processor 221 of computing device 220 may be configured to generate evaluation questions for the one or more evaluation categories using machine learning. For example, a language model may be configured to create evaluation questions for the at least one evaluation category using machine learning, such as “customer information”, “account verification”, “inquiry details”, “follow-up and next steps”. A processor such as processor 203 of computing device 202 processor 211 of device 210, and/or processor 221 of computing device 220 may be configured to provide an evaluation form based on the evaluation questions. For example, a processor such as processor 203, 211 and/or 221 may be configured to generate an evaluation form based on the evaluation questions that includes evaluation questions such as: “Did the agent perform a test to measure the internet speed?” or “Has the agent verified the current internet speed by conducting a test?”. A processor such as processor 203 of computing device 202 may be configured to receive interaction recordings, e.g. interaction transcripts, that are stored, e.g. in storage of a user device 230, an agent device 210 or server 220. A processor such as processor 203 of computing device 202 may be configured to record interactions, e.g. phone calls, text chats, etc., to generate interaction recordings, e.g. interaction transcripts. User device 230 may be a computing device, e.g. computing device 100, that is used by a user such as a supervisor of an agent or an evaluator of an agent of a contact center. For example, agent X using agent device 210 may be in a text-based chat with customer Y. Processor 211 of agent device 210 may execute an interaction recording service that records the interaction between agent X and customer Y. When the interaction ends, an interaction recording between agent X and customer Y may be stored, e.g. in storage of agent device 210 or may be sent to storage 204 of computing device 202.

FIG. 3 shows a high-level component architecture diagram of the main components of an exemplary system that is required, e.g. for the contact center solution.

A recording application 302 may be a service that is responsible for the generation of interaction recordings, e.g. the recording of audio or video packets which are sent, for example, over Session Initiation protocol (SIP) to Web Real-Time Communications (WebRTC)/Real-time Transport protocol (RTP) during agent and customer interaction. A final recorded media file and transcript of an interaction, e.g. interaction metadata and transcript 304, may be uploaded to an interaction recording data base, e.g. a scalable distributed storage device using a File Storage Service. For example, when an interaction is a digital interaction such as an interaction via chat, email, web-chat, using a computing device such as computing device 202, 210 or 230, a recording application may record a transcript of an interaction in text-based form.

An artificial intelligence platform, e.g. service 306, may be integrated into embodiments of the present invention. This service can be used for various purposes: generating one or more intents from interaction transcripts, generating possible sections/categories that must be given importance to for evaluating interaction of given intent, generating different types of questions for each category, e.g. each identified section, and generating re-phrased alternate questions for given question. For example, service 306 may be an artificial intelligence platform such as Azure Open AI by Open AI but other AI models or services known in the art may be used.

An intent identifier 308 may be a service that generates and stores intents 310 for an interaction recording, e.g. an interaction transcript 304. The generation and storing of intents 310 may proceed periodically, e.g. weekly or monthly. For example, this service may search interaction data and transcripts for skills which are identified, e.g. identified in interaction transcripts in a week or in a month. A skill may be a characteristic or qualification of an agent that corresponds to the type of interactions that are handled by the agent and can be selected e.g. automatically by an Interactive voice response system or by a supervisor of an agent. For example, a skill for an agent may be based on a channel type and an agent, who is trained in responding to customer queries via a text-based interaction may be skilled in handling an interaction with a customer, who has contacted a contact center via a text-based interaction request such as a web-chat. Interaction recordings may be incorporated into a prompt and submitted to the service 306. As a result of this prompt, service 306 may generate a short summary and description of intents that have been identified in the interaction. An intent identifier service may search an intent database, e.g. an intent and section database 312, and may store generated intents in database 312. For example, an intent is stored in a database in the case that the intent was not identified in the database during the search.

A section identifier 316 may be a service that allows generating sections/categories for one or more interaction intents, e.g. one intent, that are used in the evaluation of an interaction for a specific intent. The service may be initiated by an ‘intent identifier’ at the end of its operation. For example, a section identifier 316 retrieves generated intents 310, e.g. new intents for which sections may have not been generated. The intents 310 may be included in a section prompt to service 306 in the generation of sections. Sections generated by service 306 may be stored in an ‘intent and section’ database 312.

An intent and section database 312 may be a database that is responsible for storing intents 310 and sections 312 for the evaluation of interactions. Intents 310 and sections 312 from database 312 may be provided to form designer service 318, to present those on a user interface, e.g. a quality management (QM) web application 320, during an automatic evaluation form generation process.

A QM web application 320 may be an application that provides quality management application features to contact centers. One of the features of this application is the evaluation form management. Web application 320 may automatically prompt or request a designer service to generate evaluation forms. A form designer service may forward a request or a prompt for the generation of an evaluation form to a form generator service, which generates an evaluation form, for example using generative artificial intelligence (AI) by providing prompts to a Large Language Model (LLM), e.g. using a Chat Generative Pre-trained Transformer (ChatGPT) developed by OpenAI. An LLM can be hosted in a data cloud or can be executed by a processor of any computing device of a contact center, e.g. computing device 100 or 202. Web application 320 may present a user, e.g. supervisors and evaluators of an agent with intents and respective sections to choose from during this process. In response, form designer service may automatically return generated forms with given intent and section. This form is then rendered on user interface by QM web application.

Form designer service 322 may be a service that is responsible for managing evaluation forms. In automatic form generation flow, this service may also suggest intents and respective sections to user by retrieving them from a database, e.g. intent and section database 312. Form designer service 322 may retrieve input from QM web application 320 and pass it to e.g. to Open AI 306. Responses returned to form generator service 322 may be sections, question and answer option pairs and scores applicable for each option. Form designer service 318 may convert this response returned from form generator service 322 into evaluation form 324 which is then returned to QM web application 320. Evaluation forms 324 may be stored in a database, e.g. forms database 326.

An evaluation form database may be a database which is used for storing and retrieving evaluation forms and related details of evaluation forms, e.g. details such as the type of question, indication of the type of answer, e.g. by ticking answer boxes, in form of free text answers or yes/no answers, using a form designer service 318.

A form generator service 318 may be responsible for formulating evaluation form prompts to generate evaluation forms 324 using machine learning, e.g. using service 306. Service 306 may receive user input, e.g. intent(s) 310 and section(s) 312 for generating new evaluation forms or updating evaluation forms, e.g. updating existing questions in evaluation forms which may needs to be re-phrased. An evaluation form prompt generated by service 318 may be sent to service 306. Service 306 may generate an evaluation form, e.g. including one or more questions and answer options or re-phrased question alternatives, and may forward the generated evaluation form to a form designer service 318.

FIG. 4 shows a flowchart of a method 400 of automatically generating evaluation forms from interaction recordings, e.g. an interaction recordings which may have been received by computing device 202. The system displayed in FIG. 2 and the method shown in FIG. 4 may refer to the generation of a list of tasks from an interaction recording which have been received from an agent device, e.g. 210, or a database, e.g. server 220, however, the system and the method may also be used to generate a list of tasks from an interaction recording when executed on a server or agent device. According to some embodiments, some or all of the steps of the method are performed (e.g., fully or partially) by one or more of the computational components, for example, those shown in FIGS. 1 and 2.

In operation 402, one or more interaction intents may be identified from an interaction transcript. The identification of interaction intents may proceed by providing a machine learning model with an intent identification prompt that includes a part of an interaction transcript. For example, a prompt including an interaction transcript or excerpts of an interaction transcript may be sent to a large language model (LLM), e.g. to analyze intents for an interaction, e.g. a phone call between an agent and a customer. Intents, such as “shipping and delivery”, “password and account access” or “language and location change” may be stored in a database, e.g. database 312. An LLM can be hosted in a data cloud or can be executed by a processor of any computing device of a contact center, e.g. computing device 100 or 202.

Alternatively, desired intents may be retrieved in the absence of an interaction recording, e.g. they may be retrieved from a database, e.g. via a computing device, e.g. device 100, 202, or server 220. E.g. a company that handles predominantly shipping and delivery queries may automatically provide interaction intents, e.g. the intent “shipping and delivery” to a database, e.g. database 312.

In operation 404, one or more evaluation categories may be generated for one or more interaction intents using machine learning. Generating one or more evaluation categories may include providing a machine learning model with a category generation prompt that includes one or more identified intents, such that the model provides output of a category. For example, an excerpt of a prompt for the generation of categories or sections may read:
prompt=f“““
Create sections for evaluation form to evaluate how well the agent handled the customer call.
The customer call is for {intentObj}. Result should be in json format with “section” and “description”.
Also add maximum one section each for below
1. agent behavioral skills
2. compliance policies to be followed for {intentObj[‘domain’]}
”””
rawSections=json.loads(get_completion(prompt))
print(json.dumps(rawSections, indent=2))

For example, a prompt including intents may be sent to an LLM, e.g. to generate sections for the identified intents of operation 402. Generated sections may be stored in a database, e.g. sections and intent database 312. For example, sections for an intent “customer inquiry” may be “customer information”, “account verification”, “inquiry details” and “follow-up and next steps”.

In operation 406, evaluation questions may be generated for the one or more evaluation categories using machine learning. Generating evaluation questions may include providing a machine learning model, e.g. a LLM, with a question generation prompt that includes one or more identified intents, one or more evaluation categories, and a number setting a limit for generated evaluations questions for each of the one or more evaluation categories; the model may then output the questions. For example, a question generation prompt for the generation of evaluation questions for specific categories/sections, e.g. sections such as “compliance policies” or “agent behavioral skills”, may read:
questionTypes= [“radio”, “yes/no”, “checkbox”, “short text”, “long text”] prompt=f“““
Generate evaluation form to evaluate contact center agent performance for handling call with {intentObj}
The evaluation form should have {sections}. Follow below instructions while generating evaluation form.
1. Generate questions for each section according to description of section.
2. Number of questions in each section must be according to noOfQuestions property of section
3. Each question must be of one of the types in {questionTypes}
4. Give output in json format with following keys:
section Title
question Title
question Type
answerOptions: <as a json array with each option having text and score.>
”””
rawForm=get_completion (prompt, “You are a contact center manager who generates evaluation forms that is used by”+
“contact center evaluator to evaluate performance of agent in interaction with customer.”)
print (rawForm)

A question generation prompt may include details on the number of questions for each section and details on the answer possibilities, e.g. “yes”/“no”, in checkbox form, multi-select answers from a dropdown menu, or free text.

In some embodiments, a question generation prompt may include a customer domain, e.g. a word describing the field of business of an agent, e.g. banking, healthcare or finance interactions. For example, evaluation questions may be generated for a specific section, for example for a section “account verification” a prompt may be transmitted to an LLM to generate a number of questions, e.g. five questions related to the section “account verification”. Relevant sections for an evaluation form may be identified based on the provided service. For example, relevant sections for questions of an evaluation form for an agent may be automatically identified, e.g. by recording previously identified intents and sections for interaction recordings of an agent and generating questions that are specific to the intents and sections that have been identified in interaction recordings and, for example based on the domain of a customer, e.g. financial domain for a bank. An evaluation form may be generated using or including the questions generated by the ML model.

For example, an evaluation form may be generated for a specific field in which an interaction takes place, e.g. an interaction between a customer and a client concerning online banking issues may relate to the interaction domain banking. In an interaction, an intent “online banking password change” may be identified. Generated questions for such an intent may be: “What kind of methods did you use to verify the customer's identity before assisting them with the password change?” or “How would you handle a situation where a customer seemed reluctant to provide personal information for verification?”

For example, an evaluation form may be generated for a specific field in which an interaction takes place, e.g. an interaction between a customer and a client concerning health issues may relate to the interaction domain “healthcare”. In an interaction, an intent “Health insurance claim reimbursement” may be identified. Generated questions for such an intent may be: “Did the agent ensure the steps involved in the claim reimbursement process to a customer?” or “How did the agent handle a situation where a customer insists that certain expenses should be reimbursed even though they are not covered by the policy?”.

In operation 408, an evaluation form may be provided based on the evaluation questions. For example, an evaluation form may be based on questions that are specific to tasks of an agent. An agent dealing with customer queries in the field of banking may be provided with an evaluation form that is specific to the category “banking” and may include questions that arose based on an identified intent “online banking password change”. Generated questions for such an intent may be: “What methods did you use to verify the customer's identity before assisting them with the password change?” or “How would you handle a situation where a customer seemed reluctant to provide personal information for verification?”. In some embodiments, a generated evaluation form may be presented to a user in an editable format, e.g. to receive feedback or suggestions on an evaluation form but also to allow a user requesting refinement of questions which can initiate a refinement process e.g. as shown in FIG. 12.

Evaluation questions may be periodically updated or regenerated, e.g. evaluation questions may be updated automatically after a specific time period, e.g. a week, a month a year. Such updating may be based on interaction intents which have been identified in interactions subsequent to prior creation or updating of the questions. Evaluation questions may also be updated manually, e.g. by a user such as a supervisor of an agent of a contact center, or regenerated, e.g. when customers may be faced with an updated service or a new product. For example, when a telecommunications company markets a new phone, customers may require assistance with a new service that is provided by the phone, e.g. new e-mail service. Accordingly, questions assessing how an agents handles customer queries related to the new e-mail service may be introduced into evaluation questions for an agent of a contact center. For example, to update evaluation questions, a prompt requesting updating of evaluation questions may be sent to a LLM.

FIG. 5 is a high-level block diagram 500 showing exemplary operations in the generation of evaluation forms from interaction recordings. As shown in FIG. 5, intent identification 502 and section identification 504 may be two scheduled services that periodically, e.g. weekly or monthly retrieve interaction recordings and generate intents and sections. New interaction intents may identified within the one or more interaction intents by comparing the one or more identified interaction intents with recorded interaction intents of an interaction intent database. For example, one or more evaluation categories may generated from the new interaction intents identified in the interaction transcript. Intents and sections may be used to automatically generate evaluation forms 506 or may be presented to user, e.g. an agent supervisor or evaluator to generate or modify evaluation forms. For example, previously generated evaluation forms may be updated (508), e.g. refined based on newly identified intents and sections. Identified intents may be stored for example in an intent database 503. In one embodiment, intents may be stored together with sections, e.g. in database 505. Generated evaluation forms or updated evaluation forms may be stored in a database, e.g. database 507. A computing device, e.g. computing device 202, may receive an interaction recording, e.g. an interaction recording or transcript of an interaction stored on a server 220 or an interaction recording from an agent device such as agent device 210. Processor 203 of computing device 202 may generate an evaluation form from interaction recordings. A generated evaluation form, e.g. evaluation form 506, may be sent to a user, e.g. user device 230 via computing device 202. A user, e.g. a supervisor of an agent, may provide input to the evaluation form, e.g. by providing answers to evaluation questions of the evaluation form, e.g. evaluation form 506. A computing device, e.g. computing device 202 may receive an evaluation form from a user device, e.g. user device 230, in a filled in form. Computing device 202 may evaluate input provided by a user to evaluation questions of evaluation from 506.

FIG. 6 depicts a flowchart illustrating operations in the identification of one or more interaction intents. The purpose of this algorithm may be to identify and extract new intents present in interaction recordings, e.g. of agent-customer call conversations.

In operation 602, an interaction recording may be retrieved from a recording application, e.g. an interaction recording of a recently recorded interaction, e.g. last week or month depending on tenant configuration. For example, interaction data items for an interaction may include the following example items:

{
“interactionId”: “int_123”,
“agentId”: “agent_456”,
“skill”: “finance”,
“direction”: “inbound”,
“channelType”: “voice”,
“interactionStartTime”: “11-3-2022T5:00:00Z”,
“interactionEndTime”: “11-3-2022T5:15:00Z”
}

In operation 604, all unique skills are extracted, e.g. from interaction data items present in the interaction recording.

In operation 606, one or more interaction recordings, e.g. five interaction recordings or interaction data items with the interaction recordings, may be randomly searched for skills that have been identified in operation 604.

A large language model (LLM) may be used to identify one or more intents from an interaction transcript, e.g. a phone call conversation, for each interaction transcript (operation 608). An intent may describe a reason or purpose for an interaction, for example sale of product X to customer Y, marketing of service X to customer Z, or tech support for customer X for application W.

An excerpt of two example prompts for identifying intents within an interaction recording may read:
1. example prompt
   prompt=f“““
   Analyze the call delimited by triple backticks. The call contains the conversation between the agent and customer. Perform below
   tasks after analyzing the call.
   1. Find intent of call in max 5 words.
   2. Identify business domain
   Return results of above as a json object with keys as intent and domain.
   call=“‘{transcript}’”
   “““
   intentObj=json.loads (get_completion (prompt))
   print(intentObj)
2. example prompt
   prompt=f“““
   Describe below customer call intent from contact center in maximum 25 words.
   “‘{intentObj}’”
   ”””
   intentDescription=get_completion (prompt)
   intentObj[‘description’]=intentDescription
   print(intentObj)

Examples for intents generated by an LLM may include:

```
{
  “intent”: “Resolve internet connection issue”,
  “domain”: “Internet Service Provider”,
  “description”: “Customer seeks assistance from Internet Service Provider to resolve
internet connection issue.”
}
```

In operation 610, unique intents for a skill may be identified by comparing each intent with previously generated and/or previously recorded intents, e.g. intents stored in a database such as intent and section database (operation 612).

FIG. 7 is a high-level block diagram illustrating method of identifying intent in interaction recordings.

In operation 702, a prompt template for the generation of intents may be retrieved. An intent prompt template can be modified to create intent prompts for each interaction recording. For example, an intent prompt template may be modified to include an excerpt of an interaction recording.

In operation 704, interactions which have been received in step 606 of FIG. 6 may be selected. An interaction recording, e.g. an interaction transcript, may be retrieved from a recording application, e.g. recording application 302, (operation 706) and may be embedded in an intent prompt template, e.g. to create a prompt for specific interaction recording (operation 708). A sample of a voice interaction transcript may read:

```
{
  ″id″: 124553,
  ″interactionId″: ″ad86d017-19a7-405f-be50-90de2035213d″,
  “tenantId″: ″11ed1163-441d-0360-ac0b-0242ac110005″,
  ″messages″: [
    {
      ″id″: 1,
      ″participantType″: ″customer″,
      ″participantId″: ″+91547386393″,
      ″text″: ″I need help with password″,
      ″timestamp″: ″2022-09-17 19:08:16.259″
    },
    {
      ″id″: 2,
      ″participantType″: ″Agent″,
      ″participantId″: ″Bob″,
      ″text″: ″Sure, how can I help you?″,
      ″timestamp″: ″2022-09-17 19:08:16.712″
    },
    {
      ″id″: 3,
      ″participantType″: ″customer″,
      ″participantId″: ″+91547386393″,
      ″text″: ″I forgot my password″,
      ″timestamp″: ″2022-09-17 19:08:21.349″
    },
    {
      ″id″: 4,
      ″participantType″: ″Agent″,
      ″senderId″: ″Bob″,
      ″text″: ″I'm sorry to hear that. You can reset it at our website https://nice.com″,
      ″timestamp″: ″2022-09-17 19:08:29.967″
    }
  ]
}
```

A prompt including an interaction transcript may be processed by an LLM (operation 710) and an LLM may generate an intent identified in an interaction recording. Identified intents may be stored in a database, e.g. in form of a memory variable (operation 712).

Once the one or more transcripts have been processed in prompts and intents have been extracted using machine learning, e.g. intent identification, may stop (operation 714) and the method may proceed in operation 610 of FIG. 6.

FIG. 8 is a high-level block diagram illustrating the generation of sections from intents generated by an intent identifier, e.g. intent identifier 308. In operation 802, newly generated intents are retrieved from a database, e.g. an intent and section database 312. Retrieved intents 310 may be intents that have been generated, for example, following execution of an intent identifier service, e.g. intent identifier 308. In operation 804, the provided intents are used in the generation of section, e.g. using machine learning such as an LLM. A section prompt may be a prompt that is used in the generation of sections from intents. For example, an excerpt of a prompt for the generation of sections may read:
prompt=f“““
Create sections for evaluation form to evaluate how well the agent handled the customer call.
The customer call is for {intentObj}. Result should be in json format with “section” and “description”.
Also add maximum one section each for below
1. agent behavioral skills
2. compliance policies to be followed for {intentObj[‘domain’]}
”””
rawSections=json.loads (get_completion (prompt))
print(json.dumps(rawSections, indent=2))

In operation 806, generated sections, e.g. sections 314, may be stored in a database, e.g. in an intent and section database 312. For example, sections may include “greeting and introduction”, “active listening”, “empathy and understanding”, “problem solving”, “communication skills”, “efficiency”, “description”, “closing the call”, “overall satisfaction”.

FIG. 9 is a high-level block diagram illustrating operations in the identification of sections. A prompt template for generating sections from intents may be used to create section prompts for each intent (operation 902).

For each intent 904, a prompt may be prepared to generate sections from the intent by embedding the intents into the prompt template (operation 906). A prompt may be sent to a machine learning model, e.g. an LLM (operation 908).

Sections generated using a machine learning model, e.g. an LLM, may be saved in local storage, e.g. as a local variable (operation 910). After identification of sections for one or more intents present in interaction recordings, the section identification may be stopped (operation 912) and the method may proceed in operation (806) of FIG. 8.

FIG. 10 is a high-level block diagram illustrating operations in the generation of evaluation forms. Intents and sections may be automatically selected by a service, e.g. form designer service 318 or a QM web application 320, or may be selected by a user 1002, e.g. a supervisor of an agent or evaluator of an agent. For example, a QM web application 320, may automatically suggest intents or sections for the generation of evaluation forms or may provide a user with intents, e.g. that have been retrieved from a form designer service 318. A user may be prompted to select intents for the generation of an evaluation form. For each intent, separate evaluation form having sections and questions will be generated (operation 1004).

Sections may be retrieved from form designer service 318 for intents selected by user, e.g. user 1002 (operation 1006). For example, a user may be provided with a section that may be present in an evaluation form for each intent. Along with sections, a user can also edit a number of questions that is needed in each section. Each section may have a set number of question, e.g. 5 questions. If user needs questions more specific to intent and domain, the user can provide input to increase number of questions.

A form designer service, e.g. form designer service 318, transmit selected intents, sections and question number, e.g. user input, to form generator service 322. Form generator service 322 may generate prompts for each intent that can be submitted to a machine learning model, e.g. an LLM, to generate QM evaluation forms for all intents (operation 1008).

A QM evaluation form generated in operation 1008 may be stored, e.g. in a database such as forms database 324 by form designer service 318 (operation 1010).

FIG. 11 is a high-level block diagram illustrating the generation of evaluation forms using selected intents and sections and machine learning.

In operation 1102, automatically selected intents and sections may be retrieved from a database, e.g. an intent and section database 312. In one embodiment, intents and sections may be selected by a user, e.g. a supervisor of an agent or an evaluator of an agent, e.g. by providing input to a computer. Sections retrieved from a database, e.g. intent and section database 312 may be corelated to the selected number of questions for each evaluation section. ‘Id’ fields, e.g. that label Ids of intents or sections within database 312 may be deleted from intents and sections and intents are mapped to sections, e.g. sections may be arranged by importance, someone may sort list of sections in descending order of number of questions. Importance of a section or intent may lead to the generation of additional questions for a specific intent or section. E.g. in case that the identification of a specific soft skill of an agent is of high relevance in the assessment of an agent, the number of questions in the soft skill section may be increased, e.g. automatically or by review of the questions by a user.

In operation 1104, a base structure for the form generation prompt may be retrieved. The template for the prompt can include placeholders for the intent and sections, a number of questions per section and any other special instructions.

For each intent 1106, sections, numbers of questions per section and optionally additional details for an intent may be retrieved for the generation of a base prompt (operation 1108). Intent, sections, number of questions per section may be included in a final prompt that may be sent to an LLM. An excerpt of a sample prompt for the generation of an evaluation form may read:
questionTypes= [“radio”, “yes/no”, “checkbox”, “short text”, “long text”] prompt=f“““
Generate evaluation form to evaluate contact center agent performance for handling call
with {intentObj}
The evaluation form should have {sections}. Follow below instructions while generating evaluation form.
1. Generate questions for each section according to description of section.
2. Number of questions in each section must be according to noOfQuestions property of section
3. Each question must be of one of the types in {questionTypes}
4. Give output in json format with following keys.
   sectionTitle
   question Title
   question Type
   answerOptions: <as a json array with each option having text and score.>
”””
rawForm=get_completion (prompt, “You are a contact center manager who generates evaluation forms that is used by”+
“contact center evaluator to evaluate performance of agent in interaction with customer.”)
print (rawForm)

A prompt for the generation of an evaluation form may be sent to an LLM (operation 1112). An LLM may generate an evaluation form structure based on the evaluation form prompt. For example, a question for the section “call opening” may read “Did the agent greet the customer professionally?” or a question for the section “active listening” may read “Did the agent ask relevant questions to gather more information about the internet connection issue?” (operation 1114).

A form designer service, e.g. form designer service 318, may retrieve an evaluation form structure, e.g. including raw sections, questions and question options generated by LLM, may be retrieved from a form generator service, e.g. form generator service 322. Form designer service 318 may convert an evaluation form structure generated by an LLM into an evaluation form that can be stored, e.g. in forms database 324 (operation 1114).

FIG. 12 depicts a flowchart illustrating operations in the updating of evaluation forms, e.g. in the refinement of questions. The purpose of this algorithm may be to generate refined questions for question selected by user. In operation 1202, a request to refine an evaluation form is received, e.g. via a form designer service 318 or via received user input. For example, user input to refine an evaluation question may read:
{
   “questionId”: “q1”,
   “instructionsForRefinment”: “Question needs to be descriptive and clear”
}

Input retrieved in operation 1202 may be provided to form designer service 318. Form designer service 318 may transmit user input to a form generator service, e.g. form generator service 322. Form generator service 322 may send a prompt that includes question that may require refinement to an LLM. An LLM may generate a list of alternate questions for a question that may require refinement (operation 1204).

In operation 1206, a list of alternate questions may be provided to the user and a user may be asked to select a refined question.

In case that a user selected a refined question (1208), the flow may stop (operation 1210). In case that a user does not select a refined question (1208), a user may be prompted to provide additional instruction to refine the question (operation 1212). Additional instructions may be received, for example from a manager 1214.

Based on additional input, a prompt may be processed by an LLM (operation 1216), as outlined, e.g. in FIG. 13. A LLM may return a refined question, e.g. to a user.

FIG. 13 depicts a flowchart illustrating operations in the updating of evaluation forms. In operation 1302, details of a question that has been selected to be refined may be retrieved, e.g. from forms database 326. These details may include question text, question type, and answer choices, e.g. from a forms database 326.

In operation 1304, a question refinement prompt template may be retrieved. The template may include placeholders for the question details and user custom input/instruction (if provided).

In operation 1306, it may be checked whether or not a user has provided a custom input/instruction for question refinement.

In case that a user has provided input/instructions for question refinement, user input for the generation of a prompt may be retrieved (1310).

In case that a user has not provided input/instructions on a question or user input/instructions have already been received, details on a question selected for refinement may be embedded in a question refinement prompt template (operation 1308) to create a question refinement prompt that may be sent to an LLM. An excerpt of a sample question refinement prompt may read:
question=“agent checked internet speed?”
userInput=“Question needs to be very descriptive and clear.”
prompt=f“““
Your task is to understand the question delimited by triple backticks.
And provide 5 alternative questions.
Please note, {userInput}
question=“‘{question}”
”””
questions=get_completion (prompt, “gpt-4”)
print (questions)

In operation 1312, a prompt may be sent to a LLM to generate a refined question(s) based on the question refinement prompt.

Refined question(s) that may be returned by an LLM may be stored in a local storage in form of a memory variable.

FIG. 14 depicts an example evaluation form 1400, e.g. an evaluation form 324 as shown in FIG. 3. Evaluation form 1400 may include sections 1410 and 1420, e.g. “starting the conversation” or “conversation handling”. Each section may include evaluation question, e.g. evaluation questions 1412, 1414 or 1422. For example, evaluation question may include pre-set answer options such as “Yes” or “No”. An evaluation form may include questions that can be used to assess an agent, and may include sections for an evaluator to enter answers to the questions. For example, agents may be assessed in their behavior in interaction with customers. Evaluation form 1400 may include questions that are specific for intents or sections, e.g. intents 310 and sections 314 stored in database 312, that have been identified in previous interaction recordings. Intents and sections recorded for interactions may allow generating evaluation forms, e.g. form 1400, that include questions that are tailored to a specific task of an agent of a contact center.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A method of automatically generating evaluation forms from interaction recordings, the method comprising:
identifying one or more interaction intents from an interaction transcript;
generating one or more evaluation categories for the one or more interaction intents using machine learning;
generating evaluation questions for the one or more evaluation categories using machine learning; and
providing an evaluation form based on the evaluation questions.

2. A method according to claim 1, comprising identifying new interaction intents within the one or more interaction intents by comparing the one or more identified interaction intents with recorded interaction intents of an interaction intent database.

3. A method according to claim 2, wherein the one or more evaluation categories are generated from the new interaction intents identified in the interaction transcript.

4. A method according to claim 1, wherein identifying one or more interaction intents comprises providing the machine learning model with an intent identification prompt comprising a part of the interaction transcript.

5. A method according to claim 1, wherein generating one or more evaluation categories comprises providing the machine learning model with a category generation prompt comprising the one or more identified intents.

6. A method according to claim 1, wherein the generated evaluation questions are used to update evaluation questions in previously generated evaluation forms.

7. A method according to claim 1, wherein generating evaluation questions comprises providing the machine learning model with a question generation prompt comprising the one or more identified intents, the one or more evaluation categories, and a number setting a limit for generated evaluations questions for each of the one or more evaluation categories.

8. A method according to claim 7, wherein the question generation prompt comprises a customer domain.

9. A method according to claim 1, wherein the machine learning model is a large language model.

10. A method according to claim 1, wherein the generated evaluation forms are periodically updated based on interaction intents which have been identified in subsequent interactions.

11. A method according to claim 10, wherein the updating of generated evaluation forms comprises generating a refinement prompt that comprises evaluation questions and submitting the refinement prompt to a machine learning model.

12. A system for generating evaluation forms from interaction recordings, the system comprising:
a computing device;
a memory; and
a processor, the processor configured to:
identify one or more interaction intents from an interaction transcript;
generate one or more evaluation categories for the one or more interaction intents using machine learning;
generate evaluation questions for the one or more evaluation categories using machine learning; and
provide an evaluation form based on the evaluation questions.

13. A system according to claim 12, wherein the processor is configured to identify new interaction intents within the one or more interaction intents by comparing the one or more identified interaction intents with recorded interaction intents of an interaction intent database.

14. A system according to claim 13, wherein the one or more evaluation categories are generated from the new interaction intents identified in the interaction transcript.

15. A system according to claim 12, wherein the processor is configured to identify one or more interaction intents comprises providing the machine learning model with an intent identification prompt comprising a part of the interaction transcript.

16. A system according to claim 12, wherein the generation of evaluation questions comprises providing the machine learning model with a question generation prompt comprising the one or more identified intents, the one or more evaluation categories, and a number setting a limit for generated evaluations questions for the one or more evaluation categories.

17. A system according to claim 16, wherein the question generation prompt comprises a customer domain.

18. A system according to claim 12, wherein the machine learning model is a large language model.

19. A system according to claim 12, wherein the generated evaluation forms are periodically updated based on interaction intents which have been identified in subsequent interactions.

20. A method for generating evaluation forms from transcripts, wherein the method comprises:
identifying at least one intent in a transcript;
creating at least one evaluation category for the at least one intent using machine learning;
creating evaluation questions for the at least one evaluation category using machine learning; and
generating an evaluation form based on the evaluation questions.
